(19) United States
(12) Patent Application Publication
(10) Pub. No.: US 2025/0158884 A1
(43) Pub. Date: May 15, 2025

(54) ZERO TOUCH PROVISIONING FOR IoT DEVICES

(71) Applicant: Volta Energy Products, Inc., Buffalo, NY (US)

(72) Inventors: David CHAUNCEY, Fairport, NY (US); Jack BRODERICK, Rochester, NY (US); Jairo HERNANDEZ, Rochester, NY (US)

(21) Appl. No.: 18/433,973

(22) Filed: Feb. 6, 2024

Related U.S. Application Data
(60) Provisional application No. 63/483,454, filed on Feb. 6, 2023.

(51) Int. Cl. H04L 41/084; G16Y 40/35; H04L 41/08

(52) U.S. Cl. CPC H04L 41/084; H04L 41/0883; G16Y 40/35

(57) ABSTRACT

A method of provisioning electronic devices includes connecting at least one device to a network, using the at least one device, creating a registration request, sending the registration request to the network, using the network, processing the registration request, using the network, creating a configuration profile for the at least one device, using the network, tailoring the configuration profile for the at least one device, the at least one device receiving the configuration profile from the network, the at least one device applies the configuration profile to itself, and the at least one device connecting to the network, wherein the at least one device creates and sends the registration request and applies the configuration profile without human intervention, and wherein the at least one device may be controlled without human intervention or interaction through the use of artificial intelligence.

### CROSS-REFERENCE TO RELATED APPLICATIONS

This application claims priority to U.S. Provisional Application Ser. No. 63/483,454, entitled Zero Touch Provisioning For IoT Devices, filed 6 Feb. 2023, which is incorporated herein by reference.

### FIELD

The present teaching relates generally to device provisioning and configuring to allow a device to connect to a network, as well as providing internet, cellular, and radio network access to devices connected to the network.

### BACKGROUND

When out in the field, particularly in remote areas, internet access and cellular service can be sporadic, if not non-existent. This can cause issues for construction teams and first responders working in remote areas who need to have internet and cellular network access to do their jobs.

Another issue in the field is that in order to connect a device to a network, someone has to physically configure the device in order to connect the device to the network. However, if the device is in a hard-to-reach or dangerous location, this can be difficult and/or hazardous.

Some of the technologies used herein are as follows:

Internet of Things (IoT): The Internet of Things (IoT) is a grouping of devices with sensors, processing abilities, software, and other technologies that connect and exchange data with other devices and systems over the internet or other communications networks.

Access Point Name (APN): An Access Point Name (APN) is the name of a gateway between a mobile network and another network, frequently the internet. An APN identifies the packet data network that a mobile data user wants to communicate with.

IP Routes: IP Routes are a set of protocols that are used to allow data to travel across multiple networks from its source to its destination.

Radio Frequency Range: The Radio Frequency Range occupies a frequency range generally between 30 KHz and 300 MHz.

Cellular Frequency Range: The Cellular Frequency Range occupies a frequency range generally between 600 MHz and 39 GHz.

FirstNet: FirstNet (short for the First Responder Network Authority) is a government agency that reserves, provides, and maintains networks for first responders to use uninhibited by other network traffic. FirstNet occupies the 758 MHz to 768 MHz and the 788 MHz to 798 MHz frequency bands, which are contained within the Cellular Frequency Range.

Wi-fi Frequency Range: The Wi-fi Frequency Range occupies frequency bands including, but not limited to, 2.4 GHz, 5 GHZ, and 6 GHz.

Wide Area Network (WAN): A wide area network (WAN) is a large network of information that is not tied to a single location.

Starlink®: Starlink® is a satellite internet constellation operated by SpaceX® that provides satellite-based internet connectivity to all areas of Earth within range of the satellites.

### SUMMARY

Described herein is a device management server, wherein the device management server is stored and executed on a physical non-transitory medium, the device management server is connected to a network, and the device management server can process a registration request from at least one device, wherein the at least one device is attempting to connect to the network. The device management server can communicate with devices via an APN gateway, wherein the APN gateway is a default APN gateway before the at least one device connects to the network, wherein the APN gateway may be changed once the at least one device is connected to the network, manage the devices that are connected to the network, and can be controlled remotely by a network administrator. The device management server can process the registration request from the device without the need for human intervention or interaction. The device can be controlled without the need for human intervention or interaction using artificial intelligence. The device is an IoT capable device. Premade configuration profiles are kept in a database within the device management server to expedite the generation and tailoring of configuration profiles for the device that sent a registration request to the device management server. The registration request contains data regarding the at least one device including location data, serial number, and device model. The device management server generates and tailors configuration profiles for the device that sent a registration request to the device management server, wherein the network administrator may set parameters and provide applications to be added to the configuration profiles, and the configuration profiles are assigned geographic fences, delimited by one of the following: a circle with a radius “r”, a rectangle with an adjustable size, and a custom polygon with “n” vertices, wherein the geographic fences are set by the network administrator.

Also described herein is a method of zero touch provisioning for IoT devices, wherein at least one device connects to a network by performing the following process: the at least one device creates and sends a registration request to the network, the network processes the registration request, the network creates and tailors a configuration profile for the at least one device, the at least one device receives the configuration profile from the network, the at least one device applies the configuration profile to itself, and the at least one device then connects to the network. The device can create and send the registration request and apply the configuration profile without the need for human intervention or interaction. The device is an IoT capable device. The registration request contains data regarding the at least one device including location data, serial number, and device model. The network is bound by a geographic fence, wherein the geographic fence is delimited by one of the following: a circle with a radius “r,” a rectangle with an adjustable size, and a custom polygon with “n” vertices. The geographic fences are set by a network administrator. The configuration profile can be augmented with a list of applications and parameters to be applied to the target device, wherein the applications include protocol translation, data collection, and device enablement, and the applications and parameters are created and set by the network administrator. The location of the device defines the configuration for the device.

Still other benefits and advantages of the present subject matter will become apparent to those skilled in the art to which it pertains upon a reading and understanding of the following detailed specification.

### BRIEF DESCRIPTION OF THE DRAWINGS

The present teachings are described hereinafter with reference to the accompanying drawings.

FIG. 1 shows an overview of an exemplary device configuration process.

FIG. 2 shows a flowchart of the specifics of the exemplary device configuration process.

FIG. 3 shows an exemplary connectivity diagram of the various components of the device connected to one another, as well as which external networks this device can connect to.

FIG. 4 shows an exemplary communications diagram of the specifics of how various components of the AI Driven Battery/Telematics System communicate with one another.

FIG. 5 shows an exemplary flowchart of how the AI component of the AI Driven Battery/Telematics System may be trained, retrained, and enriched.

FIG. 6 shows an exemplary flowchart of an exemplary monitoring and control process for monitoring and controlling connected and external devices using AI driven analytics.

FIG. 7 shows an exemplary flowchart of how the AI Model within the AI Driven Device Analytics Engine 610 may be trained, retrained, and enriched.

FIG. 8 shows a flowchart of how the AI processes information regarding the past, present, and predicted future states of the system.

FIG. 9 shows a flowchart of how the system uses the virtual snapshots created by the Analytics Engine and data from various sensors and other outside sources to optimize the system's actions to reach an improved outcome.

FIG. 10 shows a flowchart of how the system uses AI engines and AI algorithms to process data and make real-time decisions without the need for human interaction or intervention.

FIG. 11 shows a flowchart of the process in which the system chooses an optimal outcome over a non-optimal outcome.

FIG. 12 shows an aspect of the Telematics Unit from FIG. 3.

### DETAILED DESCRIPTION

The following detailed description is merely exemplary in nature and is not intended to limit the described aspects or the application and uses of the described aspects. As used herein, the word “exemplary” or “illustrative” means “serving as an example, instance, or illustration.” Any implementation described herein as “exemplary” or “illustrative” is not to be construed necessarily as preferred or advantageous over other implementations. All of the implementations described below are exemplary implementations provided to enable persons skilled in the art to make or use the aspects of the disclosure and are not intended to limit the scope of the disclosure, which is defined by the claims.

Disclosed is a method and device for the operation of a system enabling onboarding of wide area network devices while removing the need to stage the target devices to apply configurations required for the device to be fully operational within the network. Also disclosed is a method and device for providing internet, radio, and cellular network access along with electric energy in the form of a battery pack, and to monitor and control the battery pack and other devices connected to the network. This system may carry out tasks and methods described herein. For example, instructions included with this system may be executable by the system or sub-systems to carry out methods shown in the Figures disclosed herein.

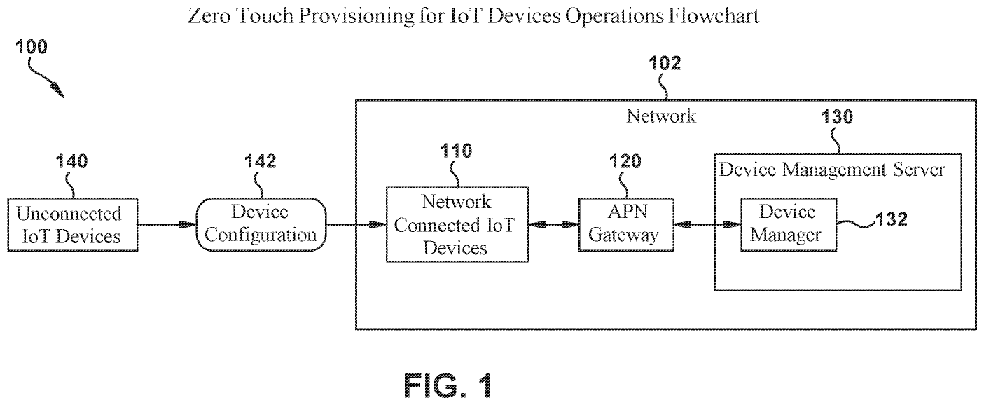

FIG. 1 schematically presents an exemplary Zero Touch Provisioning for IoT Devices Operations flowchart 100 showing an exemplary method for the operation of a system enabling onboarding of wide area network devices. This Zero Touch Provisioning for IoT Devices Operations flowchart 100 includes a Network 102, a Network Connected IoT Devices group 110, an APN Gateway 120, a Device Management Server 130, a Device Manager 132, an Unconnected IoT Devices group 140, and a Device Configuration process 142.

The Network 102 is a wireless WAN containing the Device Management Server 130 and the Network Connected IoT Devices group 110.

The Network Connected IoT Devices group 110 is a group of one or more devices that are connected to the Network 102.

The APN Gateway 120 is an APN which the devices may use to connect to the Device Manager 132 contained within the Device Management Server 130.

The Device Management Server 130 is a server operating within the Network 102 that is responsible for managing the devices that are connected to and trying to connect to the Network 102.

The Device Manager 132 is a program contained within the Device Management Server 130 that is responsible for communicating with the Network Connected IoT Devices group 110.

The Unconnected IoT Devices group 140 is a group of one or more IoT capable devices that are within the wireless range of the Network 102, are capable of being configured to connect to the Network 102 but are not connected to the Network 102. IoT capable devices within the Unconnected IoT Devices group 140 may be connected to other networks, such as wi-fi or cellular networks, so long as they are not connected to the Network 102.

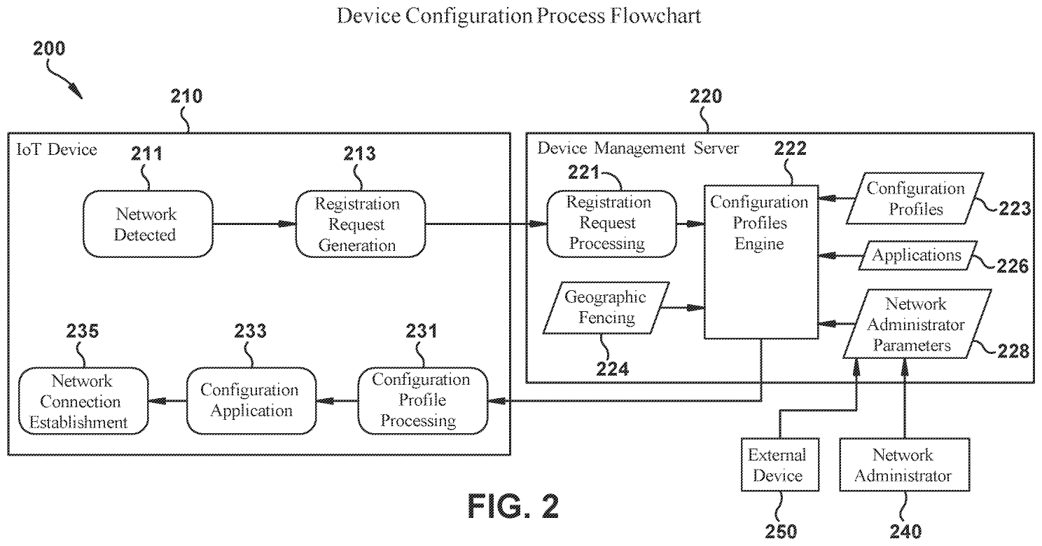

The Device Configuration process 142 is a process in which unconnected devices from the Unconnected IoT Devices group 140 are configured to connect to the Network 102, joining the Network Connected IoT Devices group 110. This process is described in detail in FIG. 2.

The flow of the Zero Touch Provisioning for IoT Devices Operations flowchart 100 is described herein. Devices within the Unconnected IoT Devices group 140 go through the Device Configuration process 142 to connect to the Network 102 and enter the Network Connected IoT Devices group 110. Devices within the Network Connected IoT Devices group 110 communicate with the Device Manager 132 via the APN Gateway 120.

This flowchart shows the process of how an IoT capable device connects to the WAN created and hosted by the battery pack device. IoT capable devices that physically enter into the geofence of the battery pack device's WAN may be configured by the battery pack device in order to connect to the WAN. Once configured, the IoT capable device may connect to the WAN.

FIG. 2 schematically represents an exemplary Device Configuration Process flowchart 200 showing the specifics of the exemplary device configuration and onboarding process which allows devices to connect to the Network 102 from FIG. 1. This Device Configuration Process flowchart 200 includes an IoT Device 210, the Device Management Server 130 from FIG. 1, a Network Administrator 240, and an External Device 250. The IoT Device 210 performs a Network Detected step 211, a Registration Request Generation step 213, a Configuration Profile Processing step 231, a Configuration Application step 233, and a Network Connection Establishment step 235. The Device Management Server 130 includes a Configuration Profiles engine 222, a Configuration Profiles database 223, a Geographic Fencing database 224, an Applications database 226, and a Network Administrator Parameters database 228. The Device Management Server 130 performs a Registration Request Processing step 221.

The IoT Device 210 is a device with IoT capabilities/containing IoT capable devices that is within the wireless range of the Network 102 and that is capable of being configured to connect to the Network 102.

The Network Detected step 211 is a step in which the IoT Device 210 detects the existence of the Network 102.

The Registration Request Generation step 213 is a step in which the IoT Device 210 generates a registration request to be sent to the Device Management Server 130 to gain access to the Network 102.

The Device Management Server 130 is a server operating within the Network 102 that is responsible for managing the devices that are connected to and trying to connect to the Network 102.

The Registration Request Processing step 221 is a step in which the Device Management Server 130 processes the registration request received from the IoT Device 210.

The Configuration Profiles Engine 222 works to create and tailor a configuration profile for a given device that is attempting to connect to the Network 102. This configuration is created and adjusted by the AI. The AI senses the conditions of the device and loads the appropriate configuration automatically.

The Configuration Profiles database 223 is a database containing a set of premade configuration profiles that the Configuration Profiles Engine 222 may use when creating and tailoring a configuration profile for a given IoT device.

The Geographic Fencing database 224 is a database containing information regarding the physical location, shape, and size of the area in which the Network 102 operates. This information is used to create one or more geographic fences (also called “geofences”) around the device. These geofences are dynamic, and the location, shape, and size of these geofences are determined by the AI based on user-supplied information.

The Applications database 226 is a database containing information regarding applications that can be added to the configuration profile to augment the IoT Device 210, enabling additional functionalities of the IoT Device 210, including but not limited to protocol translations, data collection, and device enablement.

The Network Administrator Parameters database 228 is a database containing information regarding the parameters set by the Network Administrator 240 pertaining to the configuration profiles to be sent to the IoT Device 210. These parameters are set and changed based on the device's requirements.

The Configuration Profile Processing step 231 is a step in which the IoT Device 210 processes the configuration profile sent to the IoT Device 210 by the Device Management Server 130. The configuration profiles include, but are not limited to, the configuration of the cellular network, security configurations, end device configurations, the method used to connect the device to the network, and network software versions. This configuration process is based on where the device is deployed, what the function is that the device is deployed to do, and what the device is attached to.

The Configuration Application step 233 is a step in which the IoT Device 210 applies the configuration found within the configuration profile sent to the IoT Device 210 by the Device Management Server 130. The information from the configuration profiles is loaded into the communications and end device registers.

The Network Connected Establishment step 235 is a step in which the IoT Device 210, after applying the configuration found within the configuration profile sent to the IoT Device 210 by the Device Management Server 130, connects to the Network 102.

The Network Administrator 240 is a person, group of people, or entity that controls the Network 102 and sets the various parameters within the Network 102.

The External Device 250 is an IoT capable device that is outside of the Network 102.

The flow of the Device Configuration Process flowchart 200 is described herein. The IoT Device 210 begins unconnected to the Network 102, but within the range of the Network 102. The Network Detected step 211 is a step in which the Network 102 is detected by the IoT Device 210. Once the Network 102 is detected by the IoT Device 210, the Registration Request Generation step 213 is taken by the IoT Device 210, in which the IoT Device generates a registration request to be sent to the Device Management Server 130. This registration request contains data that includes, but is not limited to, location data, the serial number of the IoT Device 210, encryption keys, and the device model of the IoT Device 210. Information regarding the encryption keys may be loaded onto the device by the manufacturer. Once this registration request is generated, it is sent to the Registration Request Processing step 221 within the Device Management Server 130 for processing. Once the registration request is processed, the information contained within the registration request is sent to the Configuration Profiles engine 222 for processing. Information from the Configuration Profiles database 223, the Geographic Fencing database 224, the Applications database 226, and the Network Administrator Parameters database 228 is sent to the Configuration Profiles engine 222 to aid in creating and tailoring a configuration profile for the IoT Device 210. The Network Administrator 240 and users using the External Device 250 set the parameters found within the Network Administrator Parameters database 228. Once the Configuration Profiles engine 222 has created and tailored a configuration profile, based on the information from within the Configuration Profiles database 223, for the IoT Device 210, the configuration profile is sent to the Configuration Profile Processing step 231 contained within the IoT Device 210 for processing. Once the configuration profile is processed, the information contained within the configuration profile is sent to the Configuration Application step 233 for applying the configuration to the IoT Device 210. Once the configuration has been applied to the IoT Device 210, the IoT Device 210 then takes the Network Connection Establishment step 235 to connect to the Network 102.

Configuration profiles are hosted on the Device Management Server 130. This server is reachable by the Network Connected IoT Devices group 110 upon joining the Network 102. The Network 102 sets a default APN as the APN Gateway 120 which allows connectivity to the Device Manager 132. Something other than the default APN can be used as part of a device from the base image of the Network Connected IoT Devices group 110. After successful provisioning (configuring), the devices from the Network Connected IoT Devices group 110 may switch APNs.

The Device Management Server 130 allows for configuration profiles to be bound to geographical locations. The Network Administrator 240 can define a set of parameters including, but not limited to, APNs, credentials, IP routes, IP addresses, and security keys. These configuration profiles can then be anchored to areas referred to as “geographical fences” or “geofences,” delimited by one of the following: a circle with a radius “r,” a rectangle with an adjustable size, and a custom polygon with “n” vertices. This geographic anchoring is established by the user of the device, and may be any arbitrary size, including but not limited to a diameter as small as 2 meters to as large as an entire continent, and may be layered to include multiple geofences that have different/additional parameters as the number of geofences is increased.

Devices from the Unconnected IoT Devices group 140 connect to the Network 102 by submitting a registration request to the Device Management Server 130. The registration request contains data that includes, but is not limited to, location data, serial number, and device model. The Device Management Server 130 responds with the corresponding configuration after consuming the data present in the request to match it with a configuration profile. When the device is manufactured, a “birth certificate” is generated for the device, proving where, when, and by whom the device was manufactured by, and this “birth certificate” is the basis of the network trusting a device and allowing it to communicate over the network.

The configuration profiles can be augmented with a list of applications and parameters to be applied to the target devices. Applications can enable additional functionality on the target device(s). Applications can include, but are not limited to, protocol translations, data collection, analytics processing, and device enablement.

The device for the operation of a system enabling onboarding of wide area network devices while removing the need to stage the target devices to apply configurations disclosed herein comprises a processor and at least one input/output. This device may be programmed remotely by the user.

One use for this device is to mount it in a substation, where it can control the various mechanisms and switches within that substation without the need for human interaction or receiving commands from an outside unit or server.

The process of configuring IoT devices that are not connected to the Network 102 is done via a separate network, such as a wi-fi network or a cellular network. Communications between the IoT Device 210 and the Device Management Server 220 occur over these separate networks during the device configuration process.

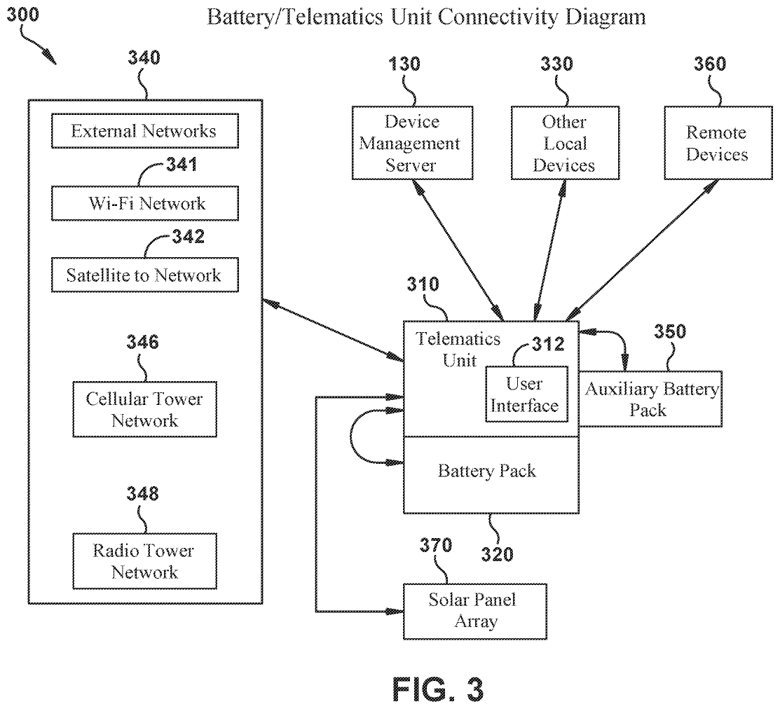

FIG. 3 schematically presents an exemplary Battery/Telematics Unit Connectivity Diagram 300 showing how the various components of the device may connect to one another, as well as which external networks the device can connect to. The Battery/Telematics Unit Connectivity Diagram 300 includes a Telematics Unit 310, a User Interface 312, the Device Management Server 130 from FIG. 1, a Battery Pack 320, an Other Local Devices group 330, an External Networks group 340, an Auxiliary Battery Pack 350, a Remote Devices group 360, and a Solar Panel Array 370. The External Networks group 340 includes a Wi-Fi Network 341, a Satellite Network 342, a Cellular Towers Network group 346, and a Radio Tower Network 348.

The Telematics Unit 310 is a device which can communicate with other devices, communicate with, and control, the Battery Pack 320 and the Solar Array 370, connect to external networks, and provide wi-fi, cellular, and/or radio network service to other devices.

The User Interface 312 allows a user to interact directly with the Telematics Unit 310 via a screen, GUI, or other control methods.

The Battery Pack 320 is a power storage device containing one or more rechargeable batteries that function as a source of power for external devices.

The Other Local Devices group 330 is a group of one or more IoT capable devices that are within a geofence of the Network 102.

The External Networks group 340 is a group of one or more networks that are outside the Network 102. This group includes but is not limited to satellite networks, wi-fi networks, FirstNet networks, cellular networks, and radio networks.

The Wi-fi Network 341 is a promulgated signal with a frequency that is within one or more of the wi-fi frequency ranges.

The Satellite Network 342 includes one or more satellites orbiting earth capable of promulgating a signal within the cellular, radio, or wi-fi frequency ranges. This network can be, but is not limited to, Starlink® and a satellite cell network.

The Cellular Towers Network group 346 is a group of cellular network towers that can promulgate signals with frequencies within the cellular frequency range. This group includes, but is not limited to, 1G, 2G, 3G, 4G/LTE, and 5G.

The Radio Tower Network 348 is a radio tower capable of promulgating signals with frequencies within the radio frequency range.

The Auxiliary Battery Pack 350 is a power storage device containing one or more rechargeable batteries and/or battery cells that function as a backup source of power for the Telematics Unit 310. In one aspect of the present teaching, the Auxiliary Battery Pack 350 includes at least one lead-acid battery cell.

The Remote Devices group 360 is a group of one or more IoT capable devices that are outside of any geofences of the Network 102.

The Solar Panel Array 370 is an array of one or more solar panels configured to provide electrical energy to at least the Battery Pack 320.

The flow of the Battery/Telematics Unit Connectivity Diagram 300 is described herein. The Telematics Unit 310 communicates with and controls the Battery Pack 320. The Telematics Unit 310 can connect to any of the networks included in the External Networks group 340. The Telematics Unit 310 communicates with the Device Management Server 130. The Telematics Unit 310 can connect to any device included in the Other Local Devices group 330 and/or the Remote Devices group 360. The Telematics Unit 310 receives information regarding power generation from and is in communication with the Solar Panel Array 370. The Auxiliary Battery Pack 350 may serve as a backup source of power to the Telematics Unit 310 when the primary source of power for the Telematics Unit 310 is unavailable.

As a non-limiting example, the Battery Pack 320 may be used in remote areas where access to a power grid is not available or not reliable and may be charged via a solar panel or other power source, such as a power grid if one is available. As a non-limiting example, the Telematics Unit 310, which may be installed on or near the Battery Pack 320, may be used to provide network connections to nearby IoT capable devices, particularly in remote areas where network connections are hard to come by or where network connections have been disrupted.

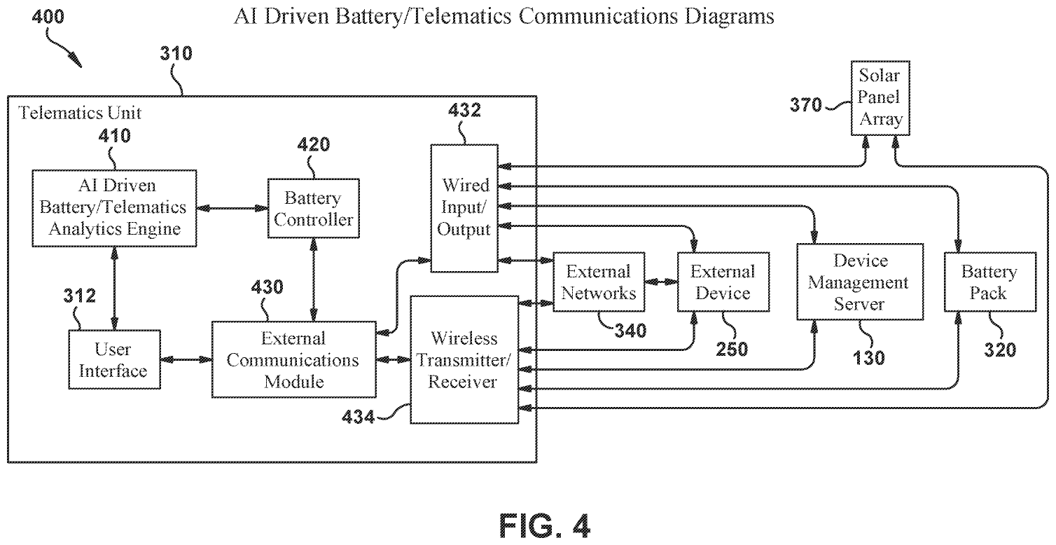

FIG. 4 schematically represents an exemplary AI Driven Battery/Telematics Communications Diagram 400 showing an exemplary monitoring and control process for the battery using AI driven analytics. The AI Driven Battery/Telematics Communications Diagram 400 includes the Telematics Unit 310 from FIG. 3, an AI Driven Battery/Telematics Analytics Engine 410, the User Interface 312 from FIG. 3, a Battery Controller 420, an External Communications Module 430, a Wired Input/Output port 432, a Wireless Transmitter/Receiver 434, the Battery Pack 320 from FIG. 3, the External Device 250 from FIG. 2, the Device Management Server 130 from FIG. 1, the External Networks group 340 from FIG. 3, and the Solar Panel Array 370 from FIG. 3.

The AI Driven Battery/Telematics Analytics Engine 410 works to control the Battery Pack 320 using current and historical data, as well as data from the Solar Panel Array 370 regarding current and past power generation, to make predictive decisions regarding power consumption and charging levels, as well as providing the analytics necessary, including current and historical connectivity data, to provide network connections to devices contained within the Other local Devices group 330 from FIG. 3.

The Battery Controller 420 monitors and controls the Battery Pack 320 via the External Communications Module 430. Parameters controlled by the Battery Controller 420 include but are not limited to the performance data, the operations data, the charge level, and the status of the Battery Pack 320.

The External Communications Module 430 allows the External Device 250, the Device Management Server 130, the External Networks group 340, and the Solar Panel Array 370 to communicate with the Battery Controller 420 and the AI Driven Battery/Telematics Analytics Engine 410. The External Communications Module 430 does this by changing the communications protocol to match the protocol of the communication with the protocol of the intended recipient of said communication.

The Wired Input/Output port 432 allows the External Device 250, the Device Management Server 130, the External Networks group 340, and the Solar Panel Array 370 to communicate with the External Communications Module 430 via a wired connection.

The Wireless Transmitter/Receiver Module 434 allows the External Device 250, the Device Management Server 130, the External Networks group 340, and the Solar Panel Array 370 to communicate with the External Communications Module 430 via a wireless connection.

The flow of the AI Driven Battery/Telematics Communications Diagram 400 is described herein. Information regarding the operation of the Battery Pack 320 is sent from the AI Driven Battery/Telematics Analytics Engine 410 to the Battery Controller 420. The Battery Controller 420 processes the information, and then controls the Battery Pack 320 in accordance with the information via the External Communications Module 430. Information regarding the status of the Battery Pack 320 is sent to the AI Driven Battery/Telematics Analytics Engine 410 via the External Communications Module 430 and the Battery Controller 420. Information regarding the status of the Battery Pack 320 is sent from the AI Driven Battery/Telematics Analytics Engine 410 and the Battery Controller 420 to the External Communications Module 430 for processing. Once processed, the information regarding the status of the Battery Pack 320 is sent to the External Device 250 via the Wired Input/Output port 432, the Wireless Transmitter/Receiver 434, and/or the External Networks group 340. Information from the External Device 250 is sent to the AI Driven Battery/Telematics Analytics Engine 410 for processing via the Wired Input/Output port 432, the Wireless Transmitter/Receiver 434, and/or the External Networks group 340, all via the External Communications Module 430. Information from the Device Management Server 130 is sent to the AI Driven Battery/Telematics Analytics Engine 410 for processing via the Wired Input/Output port 432 and/or the Wireless Transmitter/Receiver 434, all via the External Communications Module 430. Information from the Solar Panel Array 370 is sent to the AI Driven Battery/Telematics Analytics Engine 410 for processing via the Wired Input/Output port 432 and/or the Wireless Transmitter/Receiver 434, all via the External Communications Module 430. The AI Driven Battery/Telematics Analytics Engine 410 and External Communications Module 430 may communicate with the User Interface 312 to display information on the User Interface 312, and may receive inputs from the User Interface 312.

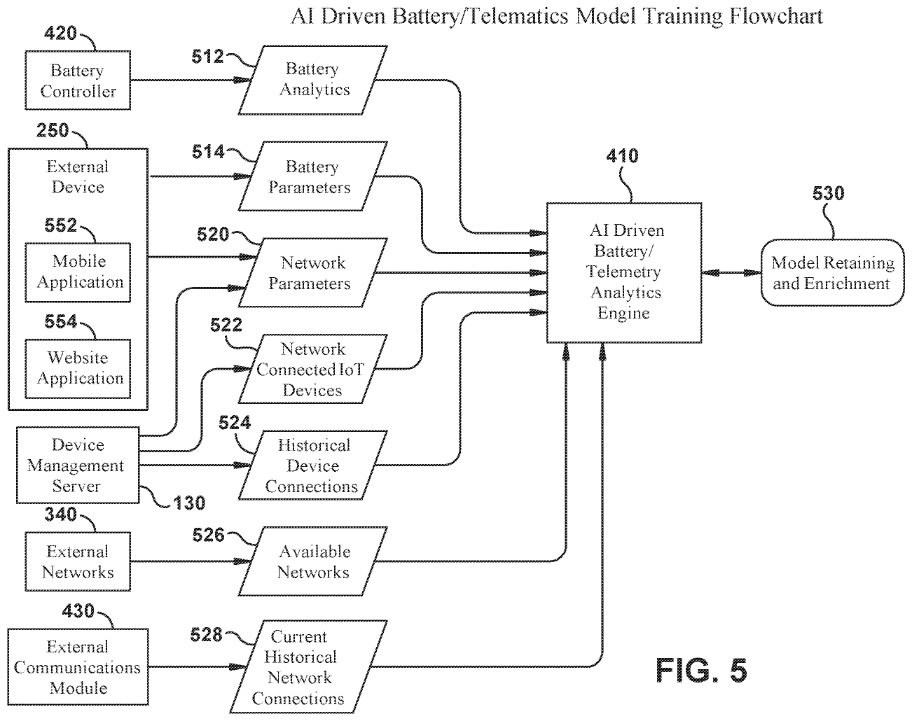

FIG. 5 schematically represents an exemplary AI Driven Battery/Telematics Model Training flowchart 500 showing how the AI model within the AI Driven Battery/Telematics Analytics Engine 410 may be trained, retrained, and enriched. This AI Driven Battery/Telematics Model Training flowchart 500 includes the Battery Controller 420 from FIG. 4, the External Device 250 from FIG. 2, the Device Management Server 130 from FIG. 1, the External Networks group 340 from FIG. 3, the External Communications Module 430 from FIG. 4, a Battery Analytics database 512, a Battery Parameters database 514, a Network Parameters database 520, a Network Connected IoT Devices database 522, a Historical Device Connections database 524, an Available Networks database 526, a Current/Historical Network Connections database 528, the AI Driven Battery/Telematics Analytics Engine 410 from FIG. 4, and a Model Retraining And Enrichment process 530. The External Device 250 includes a Mobile Application 552 and/or can access a Website Application 554.

The Battery Analytics database 512 is a database containing information regarding the status of the Battery Pack 320 from FIG. 3, including but not limited to temperature, output, and charge level.

The Battery Parameters database 514 is a database containing information regarding parameters that govern how the Battery Pack 320 operates.

The Network Parameters database 520 is a database containing information regarding parameters for the Network 102 from FIG. 1 that are set by the Network Administrator 240 from FIG. 2 and stored on the Device Management Server 130.

The Network Connected IoT Devices database 522 is a database containing information regarding what IoT enabled devices are currently connected to the Network 102.

The Historical Device Connections database 524 is a database containing information regarding IoT devices that have been connected to the Network 102 in the past but may or may not still be connected to the Network 102.

The Available Networks database 526 is a database containing information regarding the networks that are currently available from the External Networks group 340.

The Current/Historical Network Connections database 528 is a database containing information regarding networks from the External Networks group 340 that are currently connected to, or have previously been connected to, the Telematics Unit 310 from FIG. 3. This information originates from the device user.

The Model Retraining And Enrichment process 530 is a process that is continuously working to retrain and enrich the AI models used by the AI Driven Battery/Telematics Analytics Engine 410 using information from the Battery Analytics database 512, the Battery Parameters database 514, the Network Parameters database 520, the Network Connected IoT Devices database 522, the Historical Device Connections database 524, the Available Networks database 526, and the Current/Historical Network Connections database 528.

The Mobile Application 552 is an application that is downloadable onto a mobile device that allows users to control the Telematics Unit 310, as well as alter the parameters that are stored in the Network Parameters database 520.

The Website Application 554 is a website that allows users to control the Telematics Unit 310, as well as alter the parameters that are stored in the Network Parameters database 520.

The flow of the AI Driven Battery/Telematics Model Training flowchart 500 is described herein. Information from the Battery Controller 420, via the External Communications Module 430, is used to fill and augment the Battery Analytics database 512. Information from the External Device 250 is used to fill and augment the Battery Parameters database 514 and the Network Parameters database 520. Information from the Device Management Server 130 is used to fill and augment the Network Parameters database 520, the Network Connected IoT Devices database 522, and the Historical Device Connections database 524. Information from the External Networks group 340 is used to fill and augment the Available Networks database 526. Information from the External Communications Module 430 is used to fill and augment the Current/Historical Network Connections database 528. Information from the Battery Analytics database 512, the Battery Parameters database 514, the Network Parameters database 520, the Network Connected IoT Devices database 522, the Historical Device Connections database 524, the Available Networks database 526, and the Current/Historical Network Connections database 528 is sent to the AI Driven Battery/Telematics Analytics Engine 410 to create and augment the models that the AI Driven Battery/Telematics Analytics Engine 410 uses to control the Battery Pack 320,, and the Telematics Unit 310. The information contained within the AI Driven Battery/Telematics Analytics Engine 410 is continuously passed through the Model Retraining And Enrichment process 530 for augmentation and enrichment. The AI measures current data, predicts future conditions that will induce optimal performance, and then applies changes to the system to match the prediction.

The Telematics Unit 310 can connect to, control, and draw analytics from control systems located within the Battery Pack 320. The Telematics Unit 310 is capable of connecting to wi-fi networks and is capable of acting as a wi-fi hotspot. The Telematics Unit 310 is certified to operate on FirstNet. The Telematics Unit 310 is capable of connecting to cell towers, first responder towers, radio towers, and satellites. If the primary source of power used by the Telematics Unit 310, such as an electrical grid, is unavailable, the Telematics Unit 310 will draw power from the Auxiliary Battery Pack 350, as shown in FIG. 3. The Telematics Unit 310 is remotely monitorable in the Mobile Application 552 and the Website Application 554. The Telematics Unit 310 is physically monitorable from a display on the Telematics Unit 310 itself. AI can be used to regulate the Telematics Unit 310.

This system utilizes existing security features that are based on mutual authentication. Before a device can access the network, it will pass through this security.

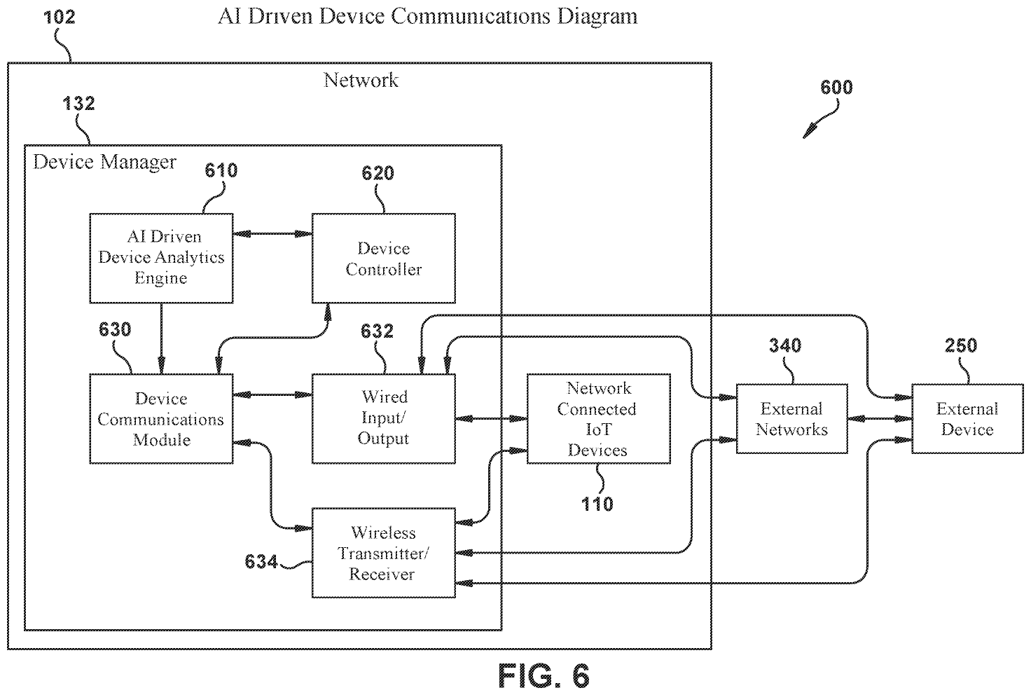

FIG. 6 schematically represents an exemplary AI Driven Device Communications Diagram 600 showing an exemplary monitoring and control process for monitoring and controlling connected and external devices using AI driven analytics. This AI Driven Device Communications Diagram 600 includes the Network 102 from FIG. 1, the Device Manager 132 from FIG. 1, an AI Driven Device Analytics Engine 610, a Device Controller 620, a Device Communications Module 630, a Wired Input/Output port 632, a Wireless Transmitter/Receiver 634, the Network Connected IoT Devices group 110 from FIG. 1, the External Networks group 340 from FIG. 3, and the External Device 250 from FIG. 2.

The AI Driven Device Analytics Engine 610 works to control devices from the Network Connected IoT Devices group 110 and external devices using current and historical data to make nearly instantaneous decisions regarding device control and operations, using pre-determined executable instructions, current conditions, historical conditions, network parameters, device parameters, and device analytics to do so.

The Device Controller 620 monitors and controls devices from the Network Connected IoT Devices group 110 and external devices, using information gleaned from the AI Driven Device Analytics Engine 610 to do so.

The Device Communications Module 630 allows the External Device 250 and devices from the Network Connected IoT Devices group 110 to communicate with the Device Controller 620 and the AI Driven Device Analytics Engine 610. The Device Communications Module 630 does this by changing the communications protocol to match the protocol of the communication with the protocol of the intended recipient of said communication.

The Wired Input/Output port 632 allows the External Device 250 and devices from the Network Connected IoT Devices group 110 to communicate with the Device Communications Module 630 via a wired connection.

The Wireless Transmitter/Receiver 634 allows the External Device 250 and devices from the Network Connected IoT Devices group 110 to communicate with the Device Communications Module 630 via a wireless connection.

The flow of the AI Driven Device Communications Diagram 600 is described herein. Information regarding the operation of devices from the Network Connected IoT Devices group 110 is sent from the AI Driven Device Analytics Engine 610 to the Device Controller 620. The Device Controller 620 processes the information and then controls devices from the Network Connected IoT Devices group 110 in accordance with the information via the Device Communications Module 630. Information regarding the status of the devices from the Network Connected IoT Devices group 110 is sent to the AI Driven Device Analytics Engine 610 via the Device Communications Module 630 and the Device Controller 620. Information regarding the status of the devices from the Network Connected IoT Devices group 110 is sent from the AI Driven Device Analytics Engine 610 and the Device Controller 620 to the Device Communications Module 630 for processing. Once processed the information regarding the status of the devices from the Network Connected IoT Devices group 110 is sent to the External Device 250 via the Wired Input/Output port 632, the Wireless Transmitter/Receiver 634, and/or the External Networks group 340. Information from the External Device 250 is sent to the AI Driven Device Analytics Engine 610 for processing via the Wired Input/Output port 632, the Wireless Transmitter/Receiver 634, and/or the External Networks group 340, all via the Device Communications Module 630. Instructions for the devices from the Network Connected IoT Devices group 110 are sent from the AI Driven Device Analytics Engine 610 to the Device Communications Module 630, then to the devices from the Network Connected IoT Devices group 110 via the Wired Input/Output port 632 and/or the Wireless Transmitter/Receiver 634.

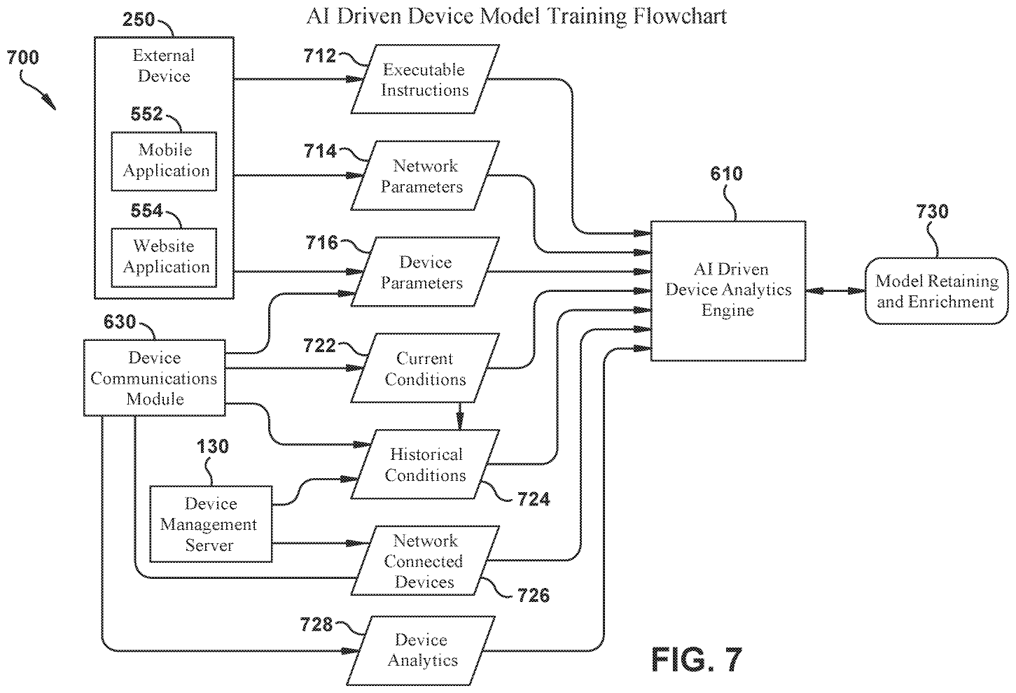

FIG. 7 schematically represents an exemplary AI Driven Device Model Training flowchart 700 showing how the AI model within the AI Driven Device Analytics Engine 610 from FIG. 6 may be trained, retrained, and enriched. This AI Driven Device Model Training flowchart 700 includes the External Device 250 from FIG. 2, the Device Communications Module 630 from FIG. 6, the Device Management Server 130 from FIG. 1, an Executable Instructions database 712, a Network Parameters database 714, a Device Parameters database 716, a Current Conditions database 722, a Historical Conditions database 724, a Network Connected Devices database 726, a Device Analytics database 728, the AI Driven Device Analytics Engine 610 from FIG. 6, and a Model Retraining And Enrichment process 730. The External Device 250 includes the Mobile Application 552 from FIG. 5 and/or can access the Website Application 554 from FIG. 5.

The Executable Instructions database 712 is a database containing information regarding instructions that are executable by the Device Controller 620 from FIG. 6. These instructions are created by a user of the system via the Mobile Application 552 and/or the Website Application contained with, or accessed via, the external device 250. These instructions can be executed without the need for the Device Controller 620 to communicate with or access an external network or a device located outside the Network 102 from FIG. 1, allowing for near instantaneous execution of the instructions.

The Network Parameters database 714 is a database containing information regarding the parameters and settings of the Network 102.

The Device Parameters database 716 is a database containing information regarding the parameters and settings for the devices from the Network Connected IoT Devices group 110 from FIG. 1.

The Current Conditions database 722 is a database containing information regarding the current conditions of the devices from the Network Connected IoT Devices group 110 and the current environmental conditions surrounding the devices from the Network Connected IoT Devices group 110.

The Historical Conditions database 724 is a database containing information regarding the historical conditions of the devices from the Network Connected IoT Devices group 110 and the historical environmental conditions surrounding the devices from the Network Connected IoT Devices group 110.

The Network Connected Devices 726 is a database containing information regarding what IoT enabled devices are currently connected to the Network 102.

The Device Analytics database 728 is a database containing information regarding the status of the devices from the Network Connected IoT Devices group 110, including but not limited to temperature, switch position, on/off status, operating instructions, and error statuses.

Other databases that this system relies on are databases containing information supplied by the device user and the device manufacturer.

The Model Retraining And Enrichment process 730 is a process that continuously works to retrain and enrich the AI models used by the AI Driven Device Analytics Engine 610 using information from the Executable Instructions database 712, the Network Parameters database 714, the Device Parameters database 716, the Current Conditions database 722, the Historical Conditions database 724, the Network Connected Devices database 726, and the Device Analytics database 728.

The flow of the AI Driven Device Model Training flowchart 700 is described herein. Information from the External Device 250 is used to fill and augment the Executable Instructions database 712, the Network Parameters database 714, and the Device Parameters database 716. Information from the Device Communications Module 630 is used to fill and augment the Device Parameters database 716, the Current Conditions database 722, the Historical Conditions database 724, the Network Connected Devices database 726, and the Device Analytics database 728. Information from the Device Management Server 130 is used to fill and augment the Historical Conditions database 724 and the Network Connected Devices database 726. Information regarding the current conditions of the system from the Current Conditions database 722 is continuously sent to augment the Historical Conditions database 724. Information from the Executable Instructions database 712, the Network Parameters database 714, the Device Parameters database 716, the Current Conditions database 722, the Historical Conditions database 724, the Network Connected Devices database 726, and the Device Analytics database 728 is sent to the AI Driven Device Analytics Engine 610 to create and augment the models that the AI Driven Device Analytics Engine 610 uses to control the devices from the Network Connected IoT Devices group 110. The information contained within the AI Driven Device Analytics Engine 610 is continuously passed through the Model Retraining And Enrichment process 730 for augmentation and enrichment.

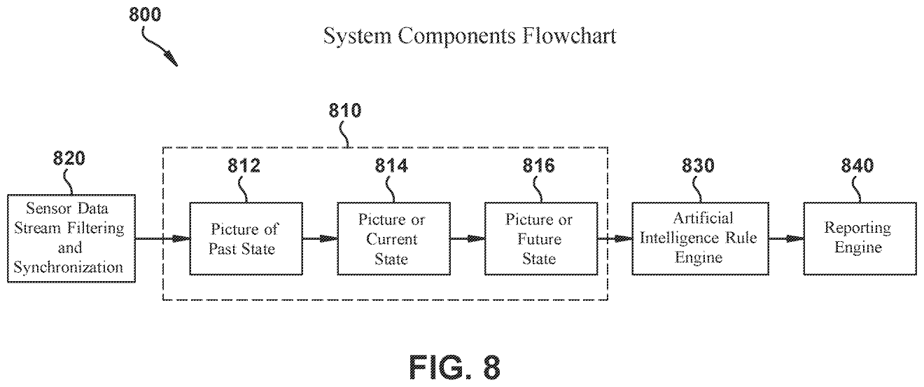

FIG. 8 schematically represents a System Components Flowchart 800 showing how the AI processes information regarding the past, present, and predicted future states of the system. This System Components Flowchart 800 includes an Analytics Engine 810, a Sensor Data Stream Filtering and Synchronization process 820, an Artificial Intelligence Rule Engine 830, and a Reporting Engine 840. The Analytics Engine includes a Picture of Past State 812, a Picture of Current State 814, and a Picture of Future State 816.

The Analytics Engine 810 is an AI engine that processes information regarding the past, present, and predicted future states of the system using information from sensors that has been filtered and synchronized.

The Picture of Past State 812 is a virtual snapshot of the system created by the Analytics Engine 810 depicting the conditions of the system from a point in time from the past.

The Picture of Current State 814 is a virtual snapshot of the system created by the Analytics Engine 810 depicting the current conditions of the system. The Analytics Engine 810 constantly generates these pictures of the system's current state via information taken from sensors that are filtered, verified, and normalized.

The Picture of Future State 816 is a virtual snapshot of the system created by the Analytics Engine 810 depicting the predicted conditions of the system at a point in time in the future using past and present data, along with data from sensors and other databases.

The Sensor Data Stream Filtering and Synchronization process 820 is a process in which information from sensors is filtered and synchronized for use by the Analytics Engine 810.

The Artificial Intelligence Rule Engine 830 is an AI engine that looks at data from databases including, but not limited to, device location, rental status, and device deployment purpose databases and compares it against the virtual snapshots created by the Analytics Engine 810 to determine what the best course of action is to reach a desired outcome. The Artificial Intelligence Rule Engine 830 performs this process independent of any human involvement or interaction and is self-learning and self-training.

The Reporting Engine 840 is an engine that generates a report using information from the Analytics Engine 810 and the Artificial Intelligence Rule Engine 830.

The flow of the System Components Flowchart 800 is described herein. The Analytics Engine 810 pulls information from the Sensor Data Stream Filtering and Synchronization process 820 to create the Picture of Past State 812. The Analytics Engine 810 pulls information from the Sensor Data Stream Filtering and Synchronization process 820 and the Picture of Past State 812 to create the Picture of Current State 814. The Analytics Engine 810 pulls information from the Sensor Data Stream Filtering and Synchronization process 820, the Picture of Past State 812, and the Picture of Current State 814 to create the Picture of Future State 816. The Artificial Intelligence Rule Engine 830 pulls information from the Analytics Engine 810 as well as outside databases to determine what actions need to be taken in order to reach a favorable or desired outcome. The Reporting Engine 840 pulls information from the Artificial Intelligence Rule Engine 830 regarding the recommended actions and creates a report reflecting those recommended actions to be used by the rest of the system and/or the user of the system.

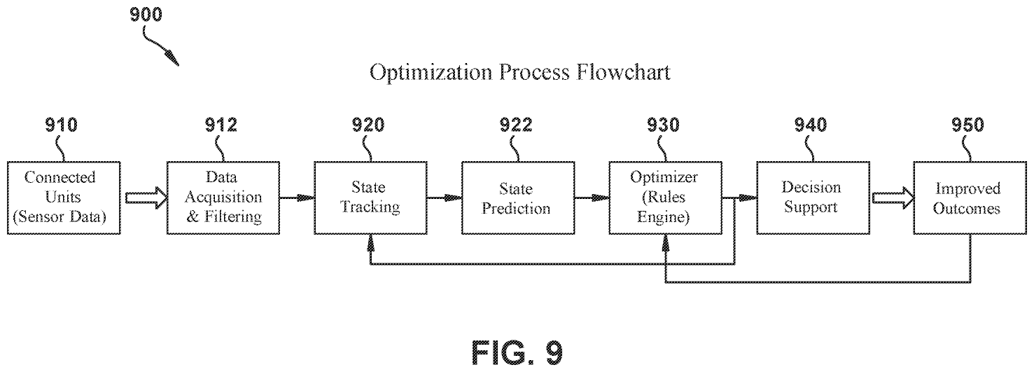

FIG. 9 schematically represents an Optimization Process Flowchart 900 showing how the system uses the virtual snapshots created by the Analytics Engine 810 from FIG. 8 and data from various sensors and other outside sources to optimize the system's actions to reach an improved outcome. This Optimization Process Flowchart 900 includes a Connected Units database 910, a Data Acquisition and Filtering process 912, a State Tracking process 920, a State Prediction process 922, an Optimizer Rules Engine 930, a Decision Support engine 940, and an Improved Outcomes Engine 950.

The Connected Units database 910 is a database containing information gleaned from sensors and other connected devices.

The Data Acquisition and Filtering process 912 is a process in which the system pulls information from the Connected Units database 910 and processes and filters it for use in the system.

The State Tracking process 920 is a process in which the system looks at and monitors its current state based on current environmental conditions surrounding the system and information pulled from the Data Acquisition and Filtering process 912.

The State Prediction process 922 is a process in which the system uses information from the State Tracking process 920 and the Optimizer Rules Engine 930 to predict what state the system will be in at a given point in time in the future.

The Optimizer Rules Engine 930 is equivalent in substance and function to the Artificial Intelligence Rule Engine 830.

The Decision Support process 940 is a process in which the system determines which action to take/optimize to achieve a desired/improved outcome.

The Improved Outcomes Engine 950 is an AI engine that determines and generates improved outcomes in real time and independent of human involvement for the system to achieve based on information regarding the current and predicted states of the system.

The flow of the Optimization Process Flowchart 900 is described herein. The State Tracking process 920 pulls information from the Connected Units database 910 via the Data Acquisition and Filtering process 912 to track the current state of the system. Information from the State Tracking process 920 is then passed to the State Prediction process 922 for predicting what state the system will be in at a given time in the future. Information from the State Prediction process 922 is sent to the Optimizer Rules Engine 930 so that the Optimizer Rules Engine 930 can determine what the most desirable outcome is. Once a desired outcome is determined, information regarding that outcome is sent from the Optimizer Rules Engine 930 to the Decision Support process 940 such that an action or actions that is/are necessary to achieve that outcome may be determined. Information regarding the desired outcome from the Optimizer Rules Engine 930 and the predicted state from the State Prediction process 922 is sent to the State Tracking process 920 to broaden the amount of information the State Tracking process 920 has to track the current state of the system. Information regarding the action or actions that is/are necessary to achieve the desired outcome is sent from the Decision Support process 940 to the Improved Outcomes Engine 950 for application to the system. Information regarding the application of the action or actions that is/are necessary to achieve the desired outcome is sent from the Improved Outcomes Engine 950 to the Optimizer Rules Engine 930 to help the Optimizer Rules Engine 930 make determinations about which outcomes are desirable based on how they are applied in the system.

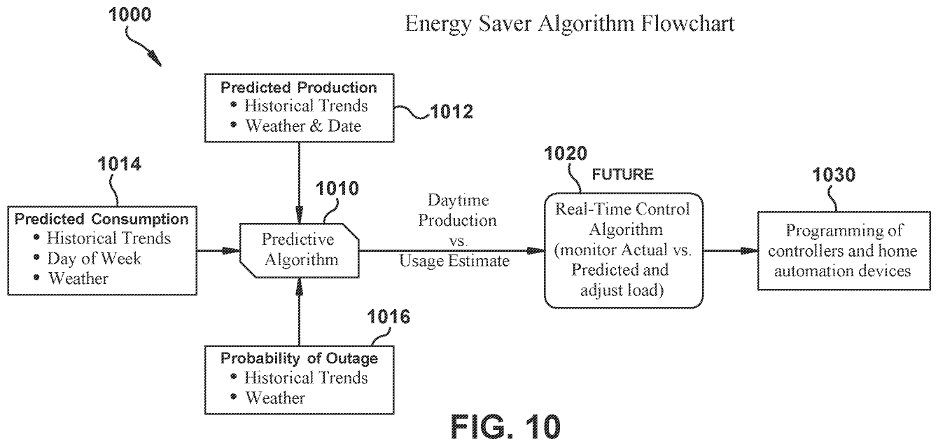

FIG. 10 schematically represents an Energy Saver Algorithm Flowchart 1000 showing a non-limiting example of how the system uses AI engines and AI algorithms to process data and make real-time decisions without the need for human interaction or intervention. The Energy Saver Algorithm Flowchart 1000 includes a Predictive Algorithm 1010, a Predicted Production engine 1012, a Predicted Consumption engine 1014, a Probability of Outage engine 1016, a Real-Time Control Algorithm 1020, and a Programming of Controllers and Home Automation Devices process 1030.

The Predictive Algorithm 1010 is an algorithm that predicts future battery usage by the system over a given period based on factors including but not limited to predicted consumption, weather, day of week, and historical trends.

The Predicted Production engine 1012 is an AI engine that predicts the production levels of a solar array, such as the Solar Array 370 from FIG. 3, based on factors including but not limited to historical data, date, and weather data.

The Predicted Consumption engine 1014 is an AI engine that predicts the consumption of the system based on factors including but not limited to historical trends, day of the week, date, and weather data.

The Probability of Outage engine 1016 is an AI engine that predicts the probability of an outage of the power grid based on factors including but not limited to historical trends, date, and weather data.

The Real-Time Control Algorithm 1020 is an algorithm used by the system to determine how the battery should be controlled. This algorithm determines what amount of the battery, if any, is allocated for consumption, how much energy is expected to be generated by the solar panels versus what will be needed from the electrical grid, and how the energy stored in the battery should be allocated in the event of an outage.

The Programming of Controllers and Home Automation Devices process 1030 is a process in which the controllers contained within the system are programmed to implement the determinations made by the system via the Real-Time Control Algorithm 1020. The Programming of Controllers and Home Automation Devices process 1030 may also control the operational parameters of the device, including but not limited to parameters of the Battery Pack 320 from FIG. 3.

The flow of the Energy Saver Algorithm Flowchart 1000 is described herein. Information generated by the Predicted Production engine 1012, the Predicted Consumption engine 1014, and the Probability of Outage engine 1016 is sent to the Predictive Algorithm 1010 for use in predicting future battery usage. Information generated by the Predictive Algorithm 1010 is sent to the Real-Time Control Algorithm 1020 for determining what amount of the battery, if any, is allocated for consumption, how much energy is expected to be generated by the solar panels versus what will be needed from the electrical grid, and how the energy stored in the battery should be allocated in the event of an outage. Information generated by the Real-Time Control Algorithm 1020 is sent to the Programming of Controllers and Home Automation Devices process 1030 for programming the controllers contained within the system to implement the energy allocation determined by the Real-Time Control Algorithm 1020.

The energy saver algorithm depicted in the Energy Saver Algorithm Flowchart 1000 is a non-limiting example of how the Telematics Unit 310 uses artificial intelligence to control and interact with the Battery Pack 320 from FIG. 3 and the Solar Panel Array 370 from FIG. 3 based on factors and data gathered in real time by various sensors, as well as historical data pulled from databases.

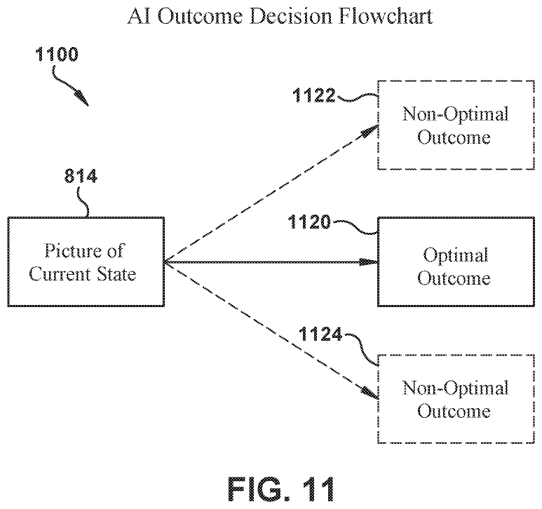

FIG. 11 schematically represents an AI Outcome Decision Flowchart 1100 showing how the system determines what the optimal outcome is of a process versus non-optimal outcomes based on information from the Picture of Current State 814 from FIG. 8 and the Decision Support process 940 from FIG. 9. The AI Outcome Decision Flowchart 1100 includes the Picture of Current State 814 from FIG. 8, an Optimal Outcome 1120, a Non-Optimal Outcome 1122, and a Non-Optimal Outcome 1124.

The Optimal Outcome 1120 is an outcome that the system has deemed to be optimal compared to other outcomes based on information from the Picture of Current State 814 and the Decision Support process 940.

The Non-Optimal Outcome 1122 is an outcome that the system has deemed to be non-optimal compared to other outcomes based on information from the Picture of Current State 814 and the Decision Support process 940.

The Non-Optimal Outcome 1124 is an outcome that the system has deemed to be non-optimal compared to other outcomes based on information from the Picture of Current State 814 and the Decision Support process 940. There may be any number of non-optimal outcomes, two non-optimal outcomes are shown in FIG. 11 as a non-limiting example.

The flow of the AI Outcome Decision Flowchart 1100 is described herein. Information from the Picture of Current State 814, in light of information from the Decision Support process 940, is used to determine which outcomes are optimal and non-optimal from a list of possible outcomes. The AI Outcome Decision Flowchart 1100 depicts an optimal outcome as the Optimal Outcome 1120 and non-optimal outcomes as the Non-Optimal Outcome 1122 and the Non-Optimal Outcome 1124 in a non-limiting fashion.

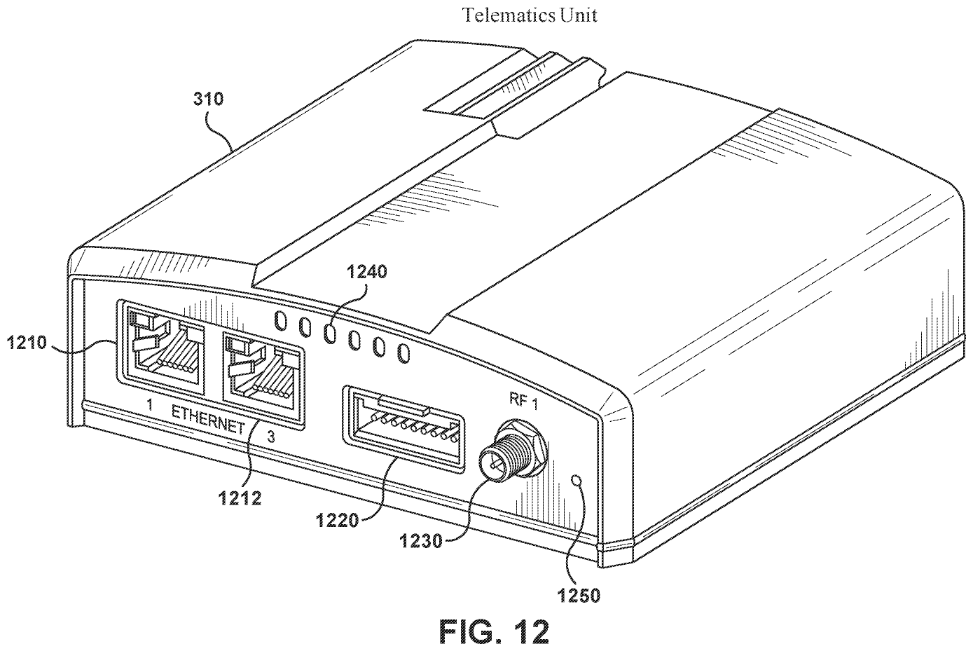

FIG. 12 schematically represents an aspect of the Telematics Unit 310 from FIG. 3. This figure depicts the Telematics Unit 310 from FIG. 3, a First Ethernet Port 1210, a Second Ethernet Port 1212, a Serial Port 1220, a Coaxial Port 1230, an Indicator Light array 1240, and a Reset Button 1250. This aspect of Telematics Unit 310 is a non-limiting example of how the Telematics Unit 310 may be configured and is not intended to limit the same.

The First Ethernet Port 1210 is a physical ethernet port that allows the Telematics Unit 310 to communicate with external devices via a wired connection using an ethernet protocol. The First Ethernet Port 1210 is a physical aspect of the Wired Input/Output port 432 from FIG. 4 and the Wired Input/Output port 632 from FIG. 6.

The Second Ethernet Port 1212 is a physical ethernet port that allows the Telematics Unit 310 to communicate with external devices via a wired connection using an ethernet protocol, independent of the First Ethernet Port 1210. The Second Ethernet Port 1212 is a physical aspect of the Wired Input/Output port 432 from FIG. 4 and the Wired Input/Output port 632 from FIG. 6.

The Serial Port 1220 is a physical serial port that allows the Telematics Unit 310 to communicate with external devices via a wired connection using a serial protocol. The Serial Port 1220 is a physical aspect of the Wired Input/Output port 432 from FIG. 4 and the Wired Input/Output port 632 from FIG. 6.

The Coaxial Port 1230 is a physical coaxial port that allows the Telematics Unit 310 to communicate with external devices via a wired connection using a coaxial protocol. The Coaxial Port 1230 is a physical aspect of the Wired Input/Output port 432 from FIG. 4 and the Wired Input/Output port 632 from FIG. 6.

The Indicator Light array 1240 is an array of lights located on the Telematics Unit 310 that allow the Telematics Unit 310 to convey information to the user, including but not limited to connection statuses and error codes. The Indicator Light array 1240 is a physical aspect of the User Interface 312 from FIG. 3.

The Reset Button 1250 is a physical button which allows the user to reset the Telematics Unit 310 when pressed. The Reset Button 1250 is a physical aspect of the User Interface 312 from FIG. 3.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the present teachings, it is now claimed:

We claim:

1. A method of provisioning for electronic devices, the method comprising the steps of:
at least one device detecting the presence of a network;
using the at least one device, creating a registration request;
sending the registration request to the network;
processing the registration request using the network;
creating a configuration profile for the at least one device using the network;
tailoring the configuration profile for the at least one device using artificial intelligence;
the at least one device receiving the configuration profile from the network;
the at least one device applying the configuration profile to itself; and
the at least one device connecting to the network.

2. The method of claim 1, wherein the at least one device is at least one IoT capable device, wherein the at least one device creates and sends the registration request and applies the configuration profile without human intervention.

3. The method of claim 1, wherein the registration request contains data regarding the at least one device comprising location data, serial number, and device model.

4. The method of claim 1, wherein the network is bound by a geographic fence.

5. The method of claim 4, wherein the geographic fence is delimited by one of the following: a circle with a radius “r,” a rectangle with an adjustable size, and a polygon with “n” vertices.

6. The method of claim 5, wherein the geographic fence is set by a network administrator.

7. The method of claim 1, wherein the configuration profile can be augmented with a list of applications and parameters to be applied to the target at least one device.

8. The method of claim 7, wherein the list of applications is chosen from the group consisting of protocol translation, data collection, and device enablement.

9. The method of claim 7, wherein the list of applications and parameters is created and set by a network administrator.

10. A device management server comprising a non-transitory computer-readable storage device storing computer executable instructions that when executed by a computer controls the computer to perform a method comprising the steps of:
connecting the device management server to a network;
processing a registration request from at least one device, wherein the at least one device is attempting to connect to the network;
communicating with the at least one device via an APN gateway;
managing the at least one device that is connected to the network;
remotely controlling the device management server by a network administrator;
processing the registration request from the at least one device without the need for human intervention or interaction; and
controlling the at least one device, without human intervention or interaction, using artificial intelligence.

11. The device management server of claim 10, wherein the at least one device is an IoT capable device.

12. The device management server of claim 10, wherein the APN gateway is a default APN gateway before the at least one device connects to the network.

13. The device management server of claim 10, wherein the APN gateway is changeable once the at least one device is connected to the network.

14. The device management server of claim 10, wherein premade configuration profiles are stored in a database within the device management server to expedite the generation and tailoring of configuration profiles for the at least one device that sent the registration request to the device management server.

15. The device management server of claim 10, wherein the registration request contains data regarding the at least one device comprising location data, serial number, and device model.

16. The device management server of claim 10, the method further comprising the step of:
generating and tailoring configuration profiles for the at least one device that sent the registration request to the device management server, wherein the configuration profiles are tailored using artificial intelligence.

17. The device management server of claim 16, wherein the network administrator sets parameters and provides applications to be added to the configuration profiles.

18. The device management server of claim 16, wherein the configuration profiles are assigned geographic fences, delimited by at least one of the following: a circle with a radius “r,” a rectangle with an adjustable size, and a polygon with “n” vertices.

19. The device management server of claim 18, wherein the geographic fences are set by the network administrator.

20. A device management server comprising a non-transitory computer-readable storage device storing computer executable instructions that when executed by a computer controls the computer to perform a method comprising the steps of:
connecting the device management server to a network;
processing a registration request from at least one device, wherein the at least one device is attempting to connect to the network, wherein the at least one device is an IoT capable device;
communicating with the at least one device via an APN gateway, wherein the APN gateway is a default APN gateway before the at least one device connects to the network, wherein the APN gateway is changeable once the at least one device is connected to the network;
managing the at least one device that is connected to the network;
remotely controlling the device management server by a network administrator;
processing the registration request from the at least one device without human intervention or interaction;
controlling the at least one device without human intervention or interaction using artificial intelligence;
storing premade configuration profiles on a database within the device management server to expedite the generation and tailoring of configuration profiles for the at least one device that sent a registration request to the device management server, wherein the registration request contains data regarding the at least one device comprising location data, serial number, and device model; and
generating and tailoring configuration profiles for the at least one device that sent the registration request to the device management server, wherein the network administrator sets parameters and provide applications to be added to the configuration profiles, and the configuration profiles are assigned geographic fences, delimited by one of the following: a circle with a radius “r,” a rectangle with an adjustable size, and a custom polygon with “n” vertices, wherein the geographic fences are set by the network administrator.
